(19) United States
(12) Patent Application Publication
(10) Pub. No.: US 2003/0125020 A1
(43) Pub. Date: Jul. 3, 2003

(54) System and method for wireless development platform

(76) Inventors: Nicolas Sauriol, Nepean (CA); Alex Sauriol, Nepean (CA)

Correspondence Address: Scott D. Balderston, Esq., Hunton & Williams, Intellectual Property Department, 1900 K Street, N.W., Suite 1200, Washington, DC, 20006, US

(21) Appl. No.: 10/029,911

(22) Filed: Dec. 31, 2001

(51) Int. Cl. H04Q 7/20

(52) U.S. Cl. 455/425; 455/558

(57) ABSTRACT

A system for a universal wireless development platform contains a PCI or other bus for receiving protocol modules used to emulate and test new or updated wireless devices, such as next-generation cellular telephones, pagers, personal digital assistants and other devices. The electronics of cellular telephones and other devices may be embedded in these removable protocol modules, for testing and alteration. Because the interfaces for various types of devices are abstracted to a removable card, one test bed may be used to build and exercise a variety of devices, without a need to use different equipment for each.

### FIELD OF THE INVENTION

The invention relates to the field of communications, and more particularly to a development platform for the rapid development of wireless systems such as network-enabled cellular telephones, and hardware and software components related thereto.

### BACKGROUND OF THE INVENTION

The wireless communication industry, including fixed and mobile cellular telephones, one and two-way paging systems, wireless personal digital assistants, and other wireless-enabled clients and other devices has proliferated in recent years. Different classes of client and other devices have adhered to different communication protocols, such as the Bluetooth standard for short-range wireless communication, 802.11a and 802.11b for longer-range open wireless LANs, CDMA, TDMA and GSM for traditional cellular telephony, GPS signals for satellite navigation, and others.

In general, there is no universal communications specification to which builders of new wireless platforms can design their devices, software and services. Therefore, the research and validation of individual systems is done in an ad hoc manner, requiring specific test beds and software for each class of device being assembled.

Because of these development constraints, manufacturers with diverse product lines and others must buy and maintain separate test equipment for different product lines. The cost of deploying, maintaining and updating wireless systems is therefore increased. Other drawbacks exist.

### SUMMARY OF THE INVENTION

The invention overcoming these and other problems in the art relates in one regard to a system and method for a wireless development platform, the platform having an extensible set of protocol modules to selectively add, drop or change the communications devices and services being prepared. In one embodiment, the wireless development platform of the invention may be implemented in a development test bed, such as a personal computer or workstation, having slots for receivable protocol modules. The protocol modules may incorporate programmable logic, such as logic arrays or processors, that may be programmed to various test and validation functions via a user interface. Because hardware design for diverse devices is unified under one interface and using a common hardware bed, development and testing costs may be significantly reduced. In another embodiment, the development test bed may include or interface to portable electronic platforms, such as notebook computers or other host devices.

### BRIEF DESCRIPTION OF THE DRAWINGS

The invention will be described with reference to the accompanying drawings, in which like elements are referenced with like numerals.

FIG. 1 illustrates a wireless development platform according to an embodiment of the invention.

FIG. 2 illustrates a protocol module for use in a wireless development platform according to an embodiment of the invention.

FIG. 3 illustrates a user interface for manipulating testing and other functions of the wireless development platform according to an embodiment of the invention.

FIG. 4 illustrates a flowchart of development processing according to an embodiment of the invention.

### DETAILED DESCRIPTION OF PREFERRED EMBODIMENTS

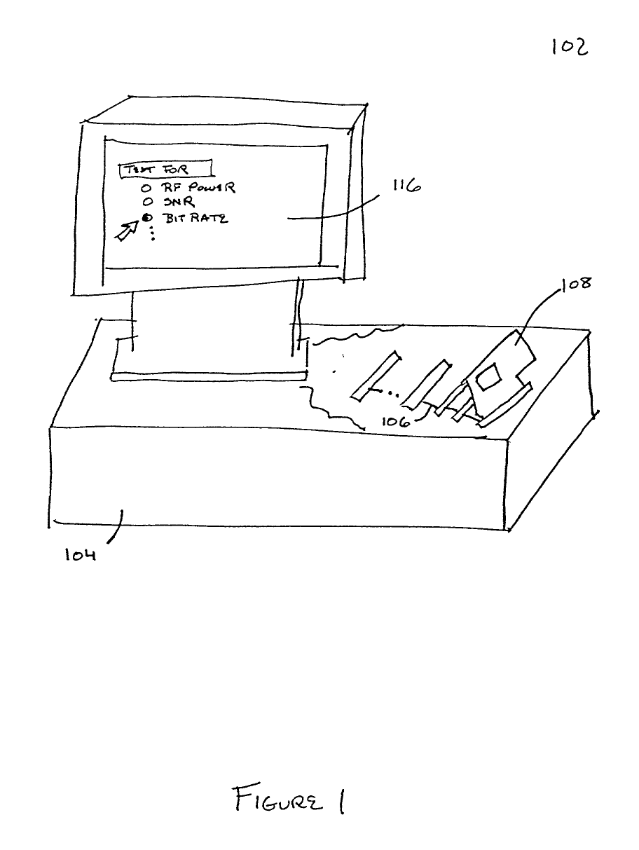

An overall architecture for a wireless development platform 102 according to the invention is illustrated in FIG. 1. According to this embodiment, the wireless development platform 102 may include a host device 104 having an electronic bus 106 receiving one or more of a protocol module 108. Because the interfaces and protocols used by different classes of wireless and network-enabled devices are abstracted to removable protocol modules 108, one wireless development platform 102 may be used to build and exercise a variety of devices, for instance to test them against standards, perform stress or burn-in tests or other purposes.

In one embodiment, the host device 104 may be, include or interface to, for instance, a personal computer running the Microsoft Windows™ 95, 98, Millenium™, NT™, 2000 or XP™, Windows™CE™, MacOS™, PalmOS™, Unix, Linux, Solaris™, OS/2™, BeOS™, MacOS™, VAX VMS or other operating system or platform. Host device 104 may include a microprocessor such as an Intel x86-based or Advanced Micro Devices x86-compatible device, a Motorola 68K or PowerPC™ device, a MIPS, Hewlett-Packard Precision™, or Digital Equipment Corp. Alpha™ RISC processor, a digital signal processor, a microcontroller or other general or special purpose device operating under programmed control.

Host device 104 may furthermore include electronic memory such as RAM (random access memory) or EPROM (electronically programmable read only memory), storage such as a hard drive, CDROM or rewritable CDROM or other magnetic, optical or other media, and other associated components connected over the electronic bus 106, as will be appreciated by persons skilled in the art. In an embodiment the electronic bus 106 may be, include or interface to a standard electronic bus having edge or other connectors such a peripheral connect interface (PCI) bus, small computer serial interface (SCSI) bus, industry standard architecture (ISA) bus, a general purpose interface (GPIB, or IEEE 488) bus, or other computer, instrumentation or other connection. The host device 104 is shown in cutaway in FIG. 1 to allow a view of the electronic bus 106 and other components, but other arrangements are possible.

Host device 104 may be equipped with an integral or connectable cathode ray tube (CRT), liquid crystal display (LCD), electroluminescent display, light emitting diode (LED) or other display screen, panel or device for viewing and manipulating files, data and other resources, for instance using a graphical user interface (GUI) or command line interface (CLI). Host device 104 may also be, include or interface to a network-enabled appliance such as a portable networkable notebook or similar computer, an intelligent instrumentation platform or other host system.

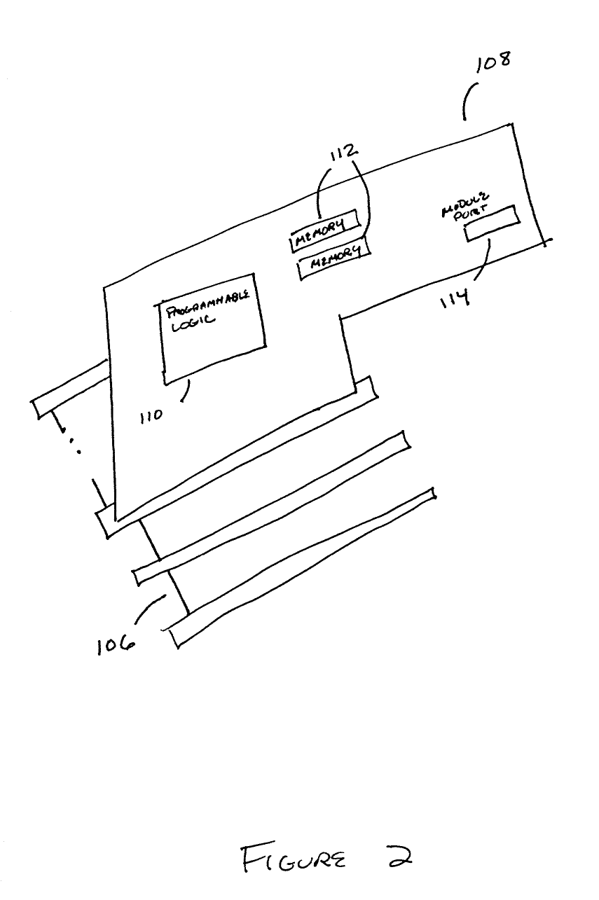

The one or more development module 108 may be received in the electronic bus 106 for purposes of initialization, testing, programming, emulating and otherwise developing communications or other wireless services. As illustrated in FIG. 2, the development module 108 may contain programmable logic 110, memory 112 and one or more module port 114. The programmable logic 110 may be, include or interface to, for instance, the embedded electronics of a cellular telephone, pager, network-enabled personal digital assistant or other wireless client to develop new models or versions of such network-enabled devices on one universal wireless development platform 102.

The one or more module port 114 of each of the one or more development module 108 may be, include or interface to, for example, a universal serial bus (USB), an integrated device electronics (IDE) bus, or other connector for testing the operation of peripheral or other electronics when connected to the protocol module 108, such as PC Card, SmartCard storage, infrared or other communications devices, or other attachments or peripherals. In embodiments, the protocol module 108 may contain RF circuitry and an antenna to test radio emissions from the test bed apparatus.

In an embodiment, the development module 108 may be configured to execute a portable operating system, such as the WindowsCE™ or Windows2000™ operating system, a version of the Linux operating system, or other operating system or environment. When so configured, software designed for eventual use in a cellular telephone or other wireless device may be tested in native mode, executing on the development module 108.

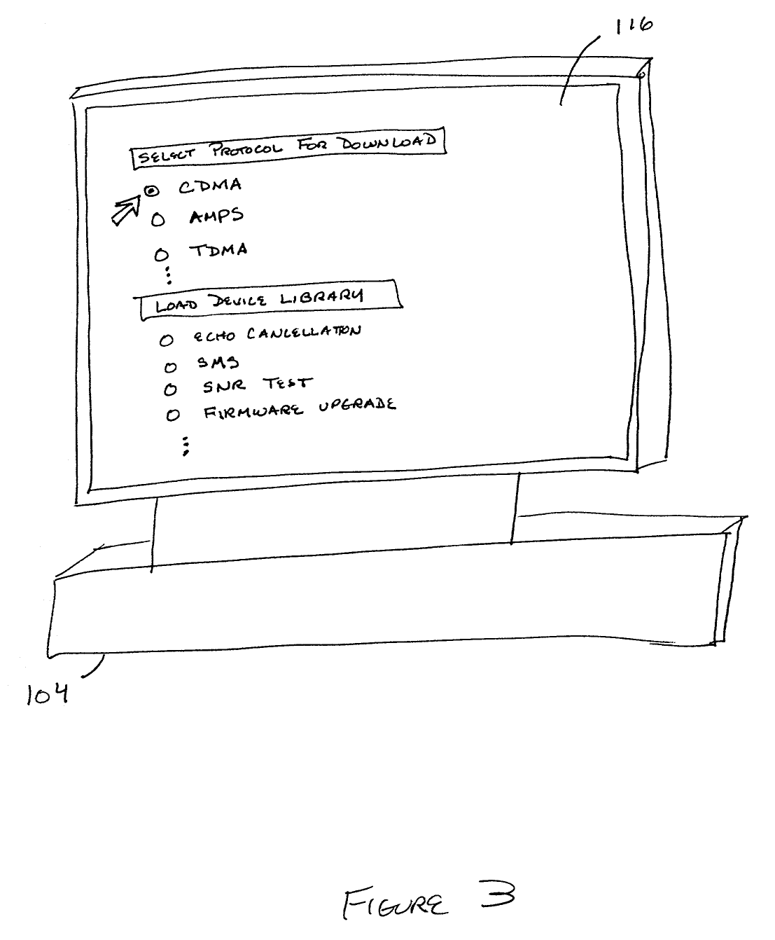

As illustrated in FIG. 3, the development module 108, when inserted for testing and development in the electronic bus 106 of host device 104, may in turn execute as a thread or process instance within the operating system of the host device 104.

Features, software settings, protocol selections and other aspects of the protocol module 108 may be displayed and manipulated on the user interface 116 of the host device 104, permitting a user to adjust the configuration of the protocol module 108 to test and emulate potential new products and enhancements, such as broadband cellular devices and others. Other configurations and layers of operating system, file sharing and other tasks are possible.

When a desired configuration is developed, the protocol and other settings may be stored to a hard disk, burned into electronic memory (EEPROM) or otherwise saved for further testing or deployment. Either one or both of the user interface 116 of the host device 104 and the operating system of the protocol module 108 may be configured to execute a network-enabled client, such as a Web browser like Microsoft Internet Explorer™, Netscape Communicator™, Opera™ or others, further reducing development costs due to standardization and the availability of plugin modules. According to an embodiment of the invention, the protocol module 108 may also execute stress tests designed to expose and isolate bugs and errors in the hardware and software of the protocol module 108, and perform other tasks.

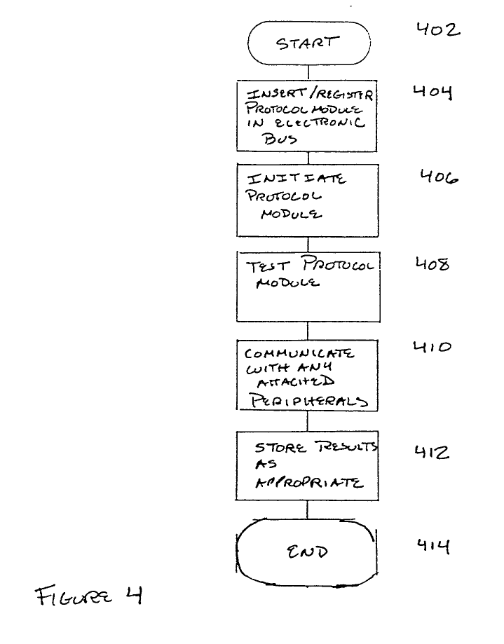

Overall development processing according to the invention is illustrated in FIG. 4. In step 402, processing begins. In step 404, one or more protocol module 108 may be registered with and detected by the electronic bus 106. In step 406, the protocol module may be initiated, for instance via the user interface 116 of the host device 104. In step 408, the user may conduct tests, install or alter software, or execute other tasks on the protocol module 108. In step 410, the protocol module 108 may communicate with any attached peripherals via the one or more module port 114. In step 412, results may be logged or stored for examination or reuse. In step 414, processing ends.

The foregoing description of the system and method of the invention is illustrative, and variations in configuration and implementation will occur to persons skilled in the art.

For instance, while the invention has been generally described with respect to a configuration where a single protocol module 108 has been inserted into the electronic bus 106 for testing and development, two or more protocol modules may be inserted and executed at the same time, for instance to develop related products or one product with more extensive electronics. Likewise, while a given protocol module 108 has generally been described as hosting one communications or other protocol or service, in embodiments one protocol module 108 may contain two or more protocols, or may be reprogrammed from one protocol to another if desired.

Moreover, while the host device 104 is generally illustrated as a single device, the functions of host device 104 may in another embodiment be distributed across a network. Other resources illustrated as plural may be combined, and those illustrated as singular may be distributed across multiple modules, platforms or devices.

The scope of the invention is accordingly intended to be limited only by the following claims.

What is claimed is:

1. A system for testing electronic devices, comprising:
at least one removable protocol module; and
at least a first user interface for operating the at least one removable protocol module in a host device.

2. The system of claim 1, wherein the at least one removable protocol module comprises at least one card, the at least one card being connectable to an electronic bus of the host device.

3. The system of claim 2, wherein the at least one card comprises programmable logic.

4. The system of claim 3, wherein the programmable logic comprises at least one wireless communication protocol.

5. The system of claim 1, wherein at least a first user interface comprises an operating system executing on at least one of the at least one protocol module and the host device.

6. The system of claim 1, wherein the at least one removable protocol module comprises two or more removable protocol modules.

7. The system of claim 1, wherein the at least a first user interface comprises at least a graphical user interface.

8. The system of claim 1, wherein the host device comprises a computer having an electronic bus.

9. The system of claim 1, wherein the operating of the at least one removable protocol module comprises at least one of testing and programming the at least one removable protocol module.

10. The system of claim 1, wherein the at least one removable protocol module comprises at least one module port.

11. A method of testing electronic devices, comprising:
a) connecting at least one removable protocol module in a host device; and
b) operating the at least one removable protocol module in the host device via at least a first user interface.

12. The method of claim 11, wherein the at least one removable protocol module comprises at least one card, the at least one card being connectable to an electronic bus of the host device.

13. The method of claim 12, wherein the at least one card comprises programmable logic.

14. The method of claim 13, wherein the programmable logic comprises at least one wireless communication protocol.

15. The method of claim 11, wherein at least a first user interface comprises an operating system executing on at least one of the at least one protocol module and the host device.

16. The method of claim 11, wherein the at least one removable protocol module comprises two or more removable protocol modules.

17. The method of claim 11, wherein the at least a first user interface comprises at least a graphical user interface.

18. The method of claim 11, wherein the host device comprises a computer having an electronic bus.

19. The method of claim 11, wherein the operating of the at least one removable protocol module comprises at least one of testing and programming the at least one removable protocol module.

20. The method of claim 11, wherein the at least one removable protocol module comprises at least one module port.
